(19) United States
(12) Patent Application Publication
(10) Pub. No.: US 2012/0159451 A1
(43) Pub. Date: Jun. 21, 2012

(54) IDENTIFYING THREADS THAT ENCOUNTER AN INSTRUCTION AT WHICH ANOTHER THREAD IS HALTED

(75) Inventor: Cary L. Bates, Rochester, MN (US)

(73) Assignee: INTERNATIONAL BUSINESS MACHINES CORPORATION, Armonk, NY (US)

(21) Appl. No.: 12/969,804

(22) Filed: Dec. 16, 2010

(51) Int. Cl. G06F 9/44

(52) U.S. Cl. 717/125; 717/129

(57) ABSTRACT

In an embodiment, execution of a first thread of a plurality of threads is halted at a first instruction. A subset of the plurality of threads is determined that execute the first instruction while the first thread is halted at the first instruction. Identifiers of the subset of the plurality of threads that execute the first instruction while the first thread is halted at the first instruction are presented via a user interface for the first thread.

### FIELD

An embodiment of the invention generally relates to computer systems and more particularly to multiple threads of a program that encounter breakpoints.

### BACKGROUND

Computer systems typically comprise a combination of computer programs and hardware, such as semiconductors, transistors, chips, circuit boards, storage devices, and processors. The computer programs are stored in the storage devices and are executed by the processors. Locating, analyzing, and correcting suspected faults in a computer program is a process known as “debugging.” Bugs are problems, faults, or errors in a computer program. Typically, a programmer uses another computer program commonly known as a debugger to debug the program under development.

Conventional debuggers typically support three primary types of operations, which a computer programmer may request via a user interface. A first type is a breakpoint or address watch operation, which permits a programmer to identify with a breakpoint a precise instruction at which to halt execution of the program by the processor, or identify via an address watch, a memory location for the processor to monitor for content modification, at which time the program's execution is halted. As a result, when a program is executed by the debugger, the program executes on the processor in a normal fashion until the breakpoint is reached or the contents of the monitored memory location are written to, at which time the debugger halts execution of the program. A second type is a step operation, which permits a computer programmer to cause the processor to execute instructions in a program either one-by-one or in groups. After each instruction or group of instructions are executed, the debugger then halts execution of the program. Once the execution of the program is halted, either by step or breakpoint operations, conventional debuggers provide a third type of operation, which displays the content that is stored at various storage locations, in response to requests by the programmer. By this debugging process of halting the program at various instructions and examining the content of various storage locations, the programmer might eventually find the storage location whose stored content, such as an instruction or data, is incorrect or unexpected.

### SUMMARY

A method, computer-readable storage medium, and computer system are provided. In an embodiment, execution of a first thread of a plurality of threads is halted at a first instruction. A subset of the plurality of threads is determined that execute the first instruction while the first thread is halted at the first instruction. Identifiers of the subset of the plurality of threads that execute the first instruction while the first thread is halted at the first instruction are presented via a user interface for the first thread.

### BRIEF DESCRIPTION OF THE SEVERAL VIEWS OF THE DRAWINGS

FIG. 1 depicts a high-level block diagram of an example system for implementing an embodiment of the invention.

FIG. 2 depicts a block diagram of an example breakpoint management table, according to an embodiment of the invention.

FIG. 3 depicts a block diagram of an example data structure for thread history data, according to an embodiment of the invention.

FIG. 4 depicts a block diagram of an example user interface presented via a user I/O (Input/Output) device, according to an embodiment of the invention.

FIG. 5 depicts a flowchart of example processing for all-threads breakpoints, according to an embodiment of the invention.

It is to be noted, however, that the appended drawings illustrate only example embodiments of the invention, and are therefore not considered a limitation of the scope of other embodiments of the invention.

### DETAILED DESCRIPTION

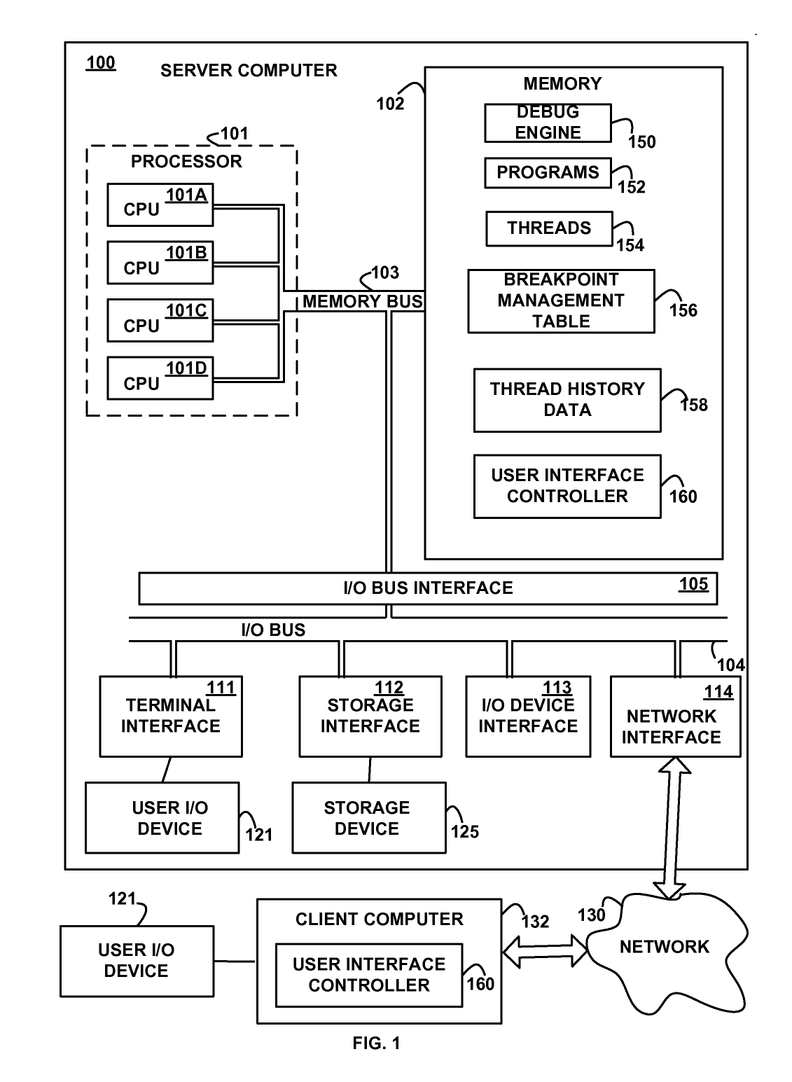

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The term “server” is used herein for convenience only, and in various embodiments a computer system that operates as a client computer in one environment may operate as a server computer in another environment, and vice versa. The mechanisms and apparatus of embodiments of the present invention apply equally to any appropriate computing system.

The major components of the computer system 100 comprise one or more processors 101, a main memory 102, a terminal interface 111, a storage interface 112, an I/O (Input/Output) device interface 113, and a network adapter 114, all of which are communicatively coupled, directly or indirectly, for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may comprise one or more levels of on-board cache.

In an embodiment, the main memory 102 may comprise a random-access semiconductor memory, storage device, or storage medium for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 102 is encoded with or stores a debug engine 150, programs 152, threads 154, a breakpoint management table 156, thread history data 158, and a user interface controller 160. Although the debug engine 150, the programs 152, the threads 154, the breakpoint management table 156, the thread history data 158, and the user interface controller 160 are illustrated as being contained within the memory 102, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, the debug engine 150, the programs 152, the threads 154, the breakpoint management table 156, the thread history data 158, and the user interface controller 160 are not necessarily all completely contained in the same storage device at the same time. Further, although the debug engine 150, the programs 152, the threads 154, the breakpoint management table 156, the thread history data 158, and the user interface controller 160 are illustrated as being separate entities, in other embodiments some of them, portions of some of them, or all of them may be packaged together.

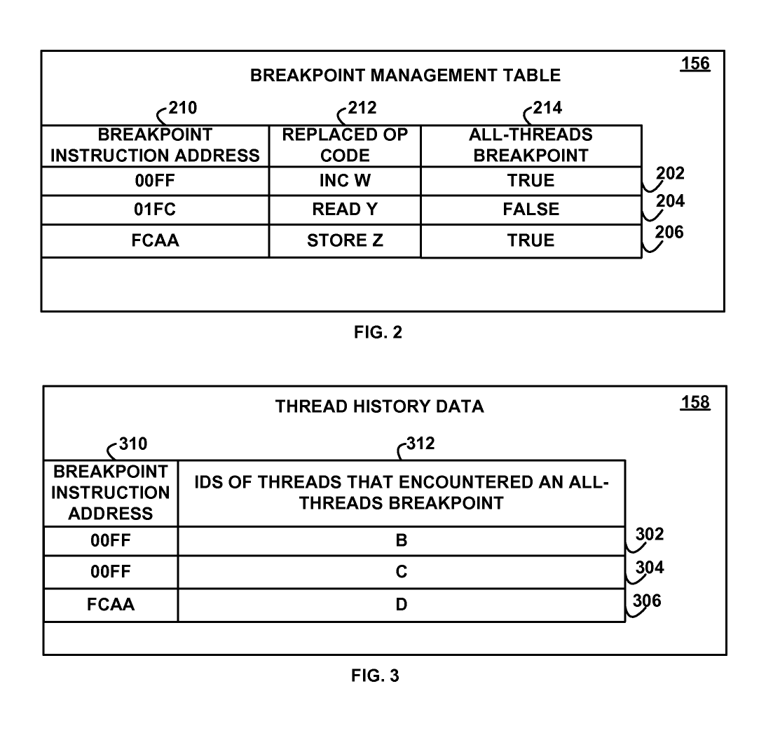

In an embodiment, the debug engine 150, the programs 152, the threads 154, and/or the user interface controller 160 comprise instructions or statements that execute on the processor 101 or instructions or statements that are interpreted by instructions or statements that execute on the processor 101, to carry out the functions as further described below with reference to FIGS. 2, 3, 4, and 5. In another embodiment, the debug engine 150, the programs 152, the threads 154, and/or the user interface controller 160 are implemented in hardware via semiconductor devices, chips, logical gates, circuits, circuit cards, and/or other physical hardware devices in lieu of, or in addition to, a processor-based system. In an embodiment, the debug engine 150, the programs 152, the threads 154, and/or the user interface controller 160 comprise data in addition to instructions or statements.

The program 152 is debugged via the debug engine 150. The program 152 may be any type of executable or interpretable code or statements, whether in source or object form. In various embodiments, the program 152 may be an application program, an operating system program, a network application program, an application server program, a server program, a grid program, a scientific calculation manager, a query optimizer, or any other type of program.

In various embodiments, the threads 154, which may also be known as processes or tasks, comprise instances of the same program 152, executing concurrently, simultaneously, or substantially simultaneously on the same or different processors via parallel computing, multi-tasking, or multiprocessing techniques. On a single processor, multithreading occurs by time-division multiplexing, as the single processor switches between different threads 154. This context switching occurs frequently enough that the user perceives the threads 154 as executing simultaneously. On a multiprocessor or multi-core computer system, the threads 154 actually execute simultaneously, with each processor or core executing a particular thread 154. In an embodiment, the threads 154 share resources, such as memory and/or a processor, but in other embodiment the threads 154 do not share resources. In an embodiment, all of the threads 154 comprise identical code, which are identical copies of the program 152. In another embodiment, some or all of the threads 154 comprise portions or subsets of the program 152, and the subsets may or may not overlap with each other.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104.

The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer system 100, and may receive output data via the user output devices. For example, a user interface may be presented via the user I/O device 121, such as displayed on a display device, played via a speaker, or printed via a printer.

The storage interface unit 112 supports the attachment of one or more disk drives or direct access storage devices 125 (which are typically rotating magnetic disk drive storage devices, although they could alternatively be other storage devices, including arrays of disk drives configured to appear as a single large storage device to a host computer). In another embodiment, the storage device 125 may be implemented via any type of secondary storage device. The contents of the main memory 102, or any portion thereof, may be stored to and retrieved from the storage device 125, as needed. The I/O device interface 113 provides an interface to any of various other input/output devices or devices of other types, such as printers or fax machines. The network adapter 114 provides one or more communications paths from the computer system 100 to other digital devices and computer systems 132; such paths may comprise, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 is a multi-user mainframe computer system, a single-user system, or a server computer or similar device that has little or no direct user interface, but receives requests from other computer systems (clients). In other embodiments, the computer system 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer system 100 and the computer system 132. In various embodiments, the network 130 may represent a storage device or a combination of storage devices, either connected directly or indirectly to the computer system 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

The client computer 132 may comprise some or all of the hardware and computer program elements of the computer 100. The client computer 132 may also comprise additional elements not illustrated for the computer 100. The client computer 132 may comprise a user interface controller 160 that manages a user interface presented or displayed via a user I/O device 121 that is connected to or contained within the client computer 132.

FIG. 1 is intended to depict the representative major components of the computer system 100, the network 130, and the client computer 132. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program components illustrated in FIG. 1 and implementing various embodiments of the invention may be implemented in a number of manners, including using various computer applications, routines, components, programs, objects, modules, data structures, etc., and are referred to hereinafter as “computer programs,” or simply “programs.”

The computer programs comprise one or more instructions or statements that are resident at various times in various memory and storage devices in the computer system 100 and that, when read and executed by one or more processors in the computer system 100 or when interpreted by instructions that are executed by one or more processors, cause the computer system 100 to perform the actions necessary to execute steps or elements comprising the various aspects of embodiments of the invention. Aspects of embodiments of the invention may be embodied as a system, method, or computer program product. Accordingly, aspects of embodiments of the invention may take the form of an entirely hardware embodiment, an entirely program embodiment (including firmware, resident programs, micro-code, etc., which are stored in a storage device) or an embodiment combining program and hardware aspects that may all generally be referred to herein as a “circuit,” “module,” or “system.” Further, embodiments of the invention may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium, may be, for example, but not limited to, an electronic, magnetic, optical, electromagnetic, infrared, or semiconductor system, apparatus, or device, or any suitable combination of the foregoing. More specific examples (an non-exhaustive list) of the computer-readable storage media may comprise: an electrical connection having one or more wires, a portable computer diskette, a hard disk (e.g., the storage device 125), a random access memory (RAM) (e.g., the memory 102), a read-only memory (ROM), an erasable programmable read-only memory (EPROM) or Flash memory, an optical fiber, a portable compact disc read-only memory (CD-ROM), an optical storage device, a magnetic storage device, or any suitable combination of the foregoing. In the context of this document, a computer-readable storage medium may be any tangible medium that can contain, or store, a program for use by or in connection with an instruction execution system, apparatus, or device.

A computer-readable signal medium may comprise a propagated data signal with computer-readable program code embodied thereon, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagates, or transports a program for use by, or in connection with, an instruction execution system, apparatus, or device. Program code embodied on a computer-readable medium may be transmitted using any appropriate medium, including but not limited to, wireless, wire line, optical fiber cable, radio frequency, or any suitable combination of the foregoing.

Computer program code for carrying out operations for aspects of embodiments of the present invention may be written in any combination of one or more programming languages, including object oriented programming languages and conventional procedural programming languages. The program code may execute entirely on the user's computer, partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments of the invention are described below with reference to flowchart illustrations and/or block diagrams of methods, apparatus (systems), and computer program products. Each block of the flowchart illustrations and/or block diagrams, and combinations of blocks in the flowchart illustrations and/or block diagrams may be implemented by computer program instructions embodied in a computer-readable medium. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified by the flowchart and/or block diagram block or blocks. These computer program instructions may also be stored in a computer-readable medium that can direct a computer, other programmable data processing apparatus, or other devices to function in a particular manner, such that the instructions stored in the computer-readable medium produce an article of manufacture, including instructions that implement the function/act specified by the flowchart and/or block diagram block or blocks.

The computer programs defining the functions of various embodiments of the invention may be delivered to a computer system via a variety of tangible computer-readable storage media that may be operatively or communicatively connected (directly or indirectly) to the processor or processors. The computer program instructions may also be loaded onto a computer, other programmable data processing apparatus, or other devices to cause a series of operational steps to be performed on the computer, other programmable apparatus, or other devices to produce a computer-implemented process, such that the instructions, which execute on the computer or other programmable apparatus, provide processes for implementing the functions/acts specified in the flowcharts and/or block diagram block or blocks.

The flowchart and the block diagrams in the figures illustrate the architecture, functionality, and operation of possible implementations of systems, methods, and computer program products, according to various embodiments of the present invention. In this regard, each block in the flowcharts or block diagrams may represent a module, segment, or portion of code, which comprises one or more executable instructions for implementing the specified logical function(s). In some embodiments, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flow chart illustrations, can be implemented by special purpose hardware-based systems that perform the specified functions or acts, in combinations of special purpose hardware and computer instructions.

Embodiments of the invention may also be delivered as part of a service engagement with a client corporation, nonprofit organization, government entity, or internal organizational structure. Aspects of these embodiments may comprise configuring a computer system to perform, and deploying computing services (e.g., computer-readable code, hardware, and web services) that implement, some or all of the methods described herein. Aspects of these embodiments may also comprise analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems. In addition, various programs described hereinafter may be identified based upon the application for which they are implemented in a specific embodiment of the invention. But, any particular program nomenclature that follows is used merely for convenience, and thus embodiments of the invention are not limited to use solely in any specific application identified and/or implied by such nomenclature. The exemplary environments illustrated in FIG. 1 are not intended to limit the present invention. Indeed, other alternative hardware and/or program environments may be used without departing from the scope of embodiments of the invention.

FIG. 2 depicts a block diagram of an example breakpoint management table 156, according to an embodiment of the invention. The breakpoint management table 156 comprises example records 202, 204, and 206, each of which comprises an example breakpoint instruction address field 210, an example replaced operation code field 212, and an example all-threads breakpoint field 214.

The example breakpoint instruction address field 210 specifies an address in the memory 102 of an instruction of the program 152 at which a breakpoint is set. The example replaced operation code 212 specifies the instruction in the program 152 located at the breakpoint instruction address 210 in the same record, at which the breakpoint is set. The debug engine 150 replaced the replaced operation code 212 with an invalid instruction, which causes a system exception in response to the execution of the program 152 encountering the invalid instruction at the breakpoint instruction address 210, in the same record. The all-threads breakpoint field 214 indicates whether or not the debug engine 150 has designated the breakpoint at the breakpoint instruction address 210 as an all-threads breakpoint. Breakpoints that are not designated as all-threads breakpoints were set by the debug engine 150 in response to a user-initiated command, which requested that the breakpoint be set at the breakpoint instruction address 210, in the same record. Breakpoints that are designated as all-threads breakpoints were set by the debug engine 150 in response to execution of a thread halting and remain set until the execution of the halted thread resumes.

FIG. 3 depicts a block diagram of an example data structure for thread history data 158, according to an embodiment of the invention. The thread history data 158 comprises example records 302, 304, and 306, each of which comprises an example breakpoint instruction address field 310 and a thread identifier field 312. The breakpoint instruction address 310 specifies an instruction in the program 152 located at the breakpoint instruction address 310, at which a thread of the program 152 identified by the thread identifier 312, in the same record, encountered an all-threads breakpoint. The thread identifier 312 identifies a thread that encountered an all-threads breakpoint, meaning that a thread identified by the thread identifier 312 executed an instruction at the breakpoint instruction address 310 while another thread is halted at that same breakpoint instruction address 310, in the same record.

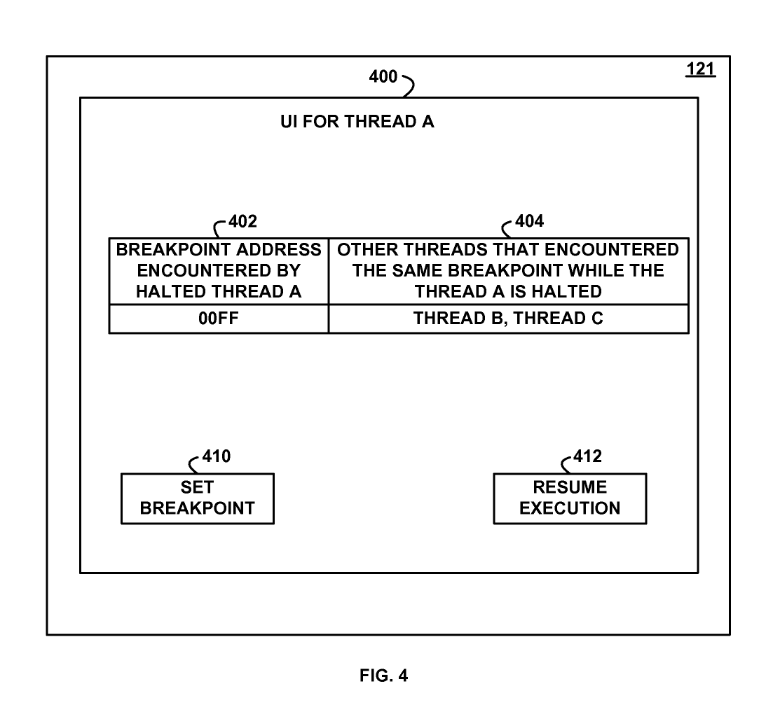

FIG. 4 depicts a block diagram of an example user interface 400 presented via a user I/O (Input/Output) device 121, according to an embodiment of the invention. The user interface 400 comprises a breakpoint address field 402 and a thread identifier field 404. The breakpoint address field 402 specifies an address, instruction number, or statement number of an instruction or statement in the program 152 and/or the instruction or statement, at which the execution of the thread A is halted. The thread identifier field 404 identifies the thread or threads (a subset of all of the threads 154) whose execution encountered the same instruction at the same address 402 while the thread A is halted. In embodiment, the threads identified by the thread identifier field 404 are of interest to the user because the threads identified by the thread identifier field 404 are executing the same instruction as the thread that is halted and thus may have an impact on the thread that is halted and being debugged.

The user interface 400 further comprises a set breakpoint command 410 and a resume execution command 412. The selection of the respective command 410 or 412 via the user I/O device 121 sends the respective command to the debug engine 150 via the user interface controller 160 and requests that the debug engine 150 set a breakpoint at a specified instruction or statement address in the program 152 or requests that the debug engine 150 resume execution of the halted thread A of the program 152. Although the commands 410 and 412 are illustrated in FIG. 4 as buttons, in other embodiments, they may be textual commands entered via a command line, menu options, or commands entered via a speech recognition system.

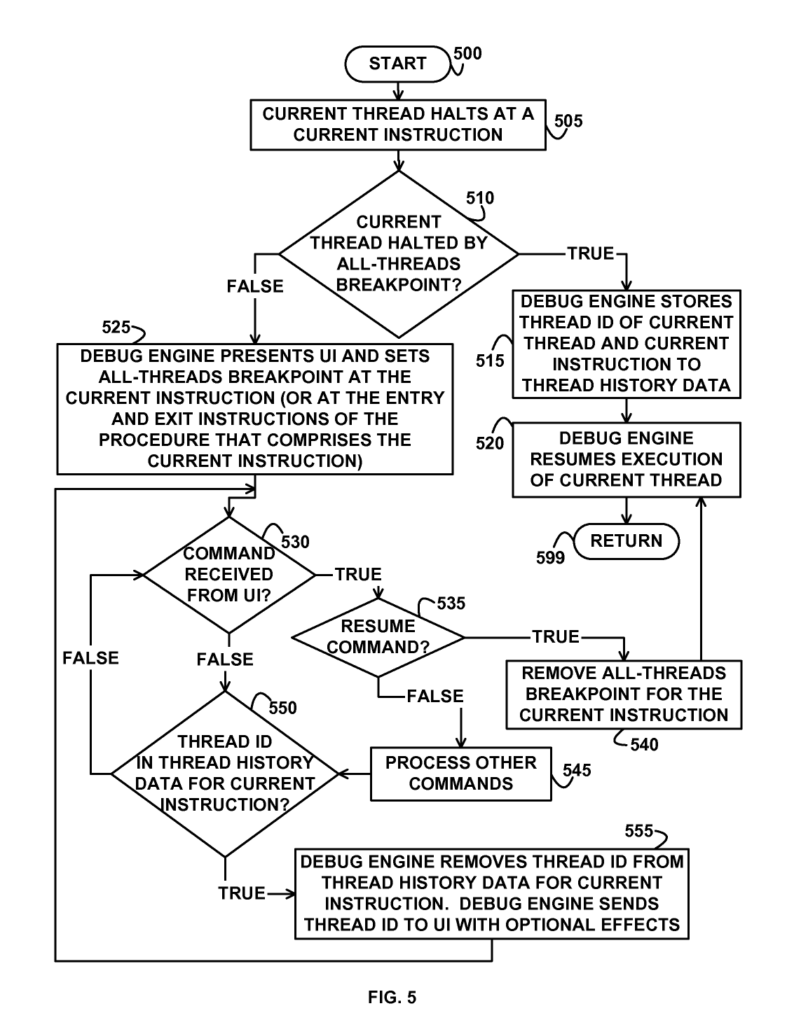

FIG. 5 depicts a flowchart of example processing for all-threads breakpoints, according to an embodiment of the invention. Control begins at block 500. Control then continues to block 505 where the execution of a current thread on the processor 101 halts at a current instruction and the debug engine 150 receives control of the processor 101. Control then continues to block 510 where the debug engine 150 determines whether the current thread halted because the current thread encountered an all-threads breakpoint. The debug engine 150 makes the determination at block 510 by determining whether the current thread halted because of a breakpoint, and if the current thread halted because of a breakpoint, finding the record in the breakpoint management table 156 that comprises a breakpoint instruction address 210 that matches (is identical to) the current instruction and determining whether the all-threads breakpoint field 214 in the same record indicates that the matched breakpoint 210 is an all-threads breakpoint.

If the determination at block 510 is true, then the current thread halted because the execution of the current thread encountered an instruction where an all-threads breakpoint is set, so control continues to block 515 where the debug engine 150 stores the current instruction or an identifier or address of the current instruction and the thread identifier of the current thread to the thread history data 158 as the breakpoint instruction address 310 and the thread identifier 312, respectively. Control then continues to block 520 where the debug engine 150 resumes execution of the current thread on the processor 101. Since the debug engine 150 did not give control to a user interface, in an embodiment, a user viewing the user I/O device 121 is unaware that the current thread encountered the all-threads breakpoint. Control then continues to block 599 where the logic of FIG. 5 returns.

If the determination at block 510 is false, then the current thread did not halt because of an all-threads breakpoint. In various embodiments, the current thread may have halted because the current thread encountered a user breakpoint, i.e., a breakpoint set at the request of the user, e.g., via the set breakpoint command 410, or the current thread encountered an address watch or a system exception or error. If the current thread did not halt because of an all-threads breakpoint, then control continues from block 510 to block 525 where the debug engine 150 presents or displays a user interface, e.g., the user interface 400, via the user I/O device 121. The debug engine 150 further sets an all-threads breakpoint at the current instruction, storing the address of the current instruction to the breakpoint instruction address 210, replacing the operation code at the breakpoint instruction address with an invalid instruction, storing the replaced operation code to the replaced operation code 212 in the same record of the breakpoint management table 156, and setting the all-threads breakpoint field in the same record to indicate that the breakpoint is an all-threads breakpoint. In another embodiment, the debug engine 150 sets an all-threads breakpoint at the entry (the first) instruction and another all-threads breakpoint at the exit (the last) instruction of the procedure, sub-procedure, method, module, or other unit of the current thread that comprises the current instruction and that was executing at the time that the current thread halted.

Control then continues to block 530 where the debug engine 150 determines whether the debug engine 150 has received a command from the user I/O device 121 or from the user I/O device 121 via the user interface controller 160. If the determination at block 530 is true, the debug engine 150 received a command, so control continues to block 535 where the debug engine 150 determines whether the received command is a command that requests that execution of the halted thread be resumed, such as the resume execution command 412.

If the determination at block 535 is true, then the received command is a resume execution command, so control continues to block 540 where, in response to the resume execution command, the debug engine 150 removes or deletes the all-threads breakpoint at the current instruction, which the debug engine 150 previously set, as described above with reference to block 525. The debug engine 150 deletes the record for the all-threads breakpoint at the current instruction (the record with a breakpoint instruction address 210 that matches the current instruction) from the breakpoint management table 156 and replaces the invalid operation code at the address of the current instruction with the replaced operation code 212 from the deleted record. The debug engine 150 removes the all-threads breakpoint for the current instruction because the debug engine 150 set the all-threads breakpoint while the current thread was halted for the purpose of finding other threads that execute the same code as the halted current thread while the current thread is halted. Once the current thread resumes execution and is no longer halted, the debug engine 150 no longer needs the all-threads breakpoint. Control then continues to block 520 where the debug engine 150 resumes execution of the current thread on the processor 101. Control then continues to block 599 where the logic of FIG. 5 returns.

If the determination at block 535 is false, then the received command is not a resume execution command, so control continues to block 545 where the debug engine 150 processes other commands, e.g., the set breakpoint command 410. Control then continues to block 550 where the debug engine 150 determines whether the thread history data 158 comprises at least one record that comprises a breakpoint instruction address field 310 that matches (is identical to) the current instruction, and that record comprises a thread identifier field 312 with a thread identifier that is different than the identifier of the current halted thread.

If the determination at block 550 is true, then the thread history data 158 comprises at least one record that comprises a breakpoint instruction address field 310 that matches (is identical to) the current instruction, and that record comprises a thread identifier field 312 with a thread identifier that is different than the identifier of the current halted thread, so one or more other threads have encountered the same breakpoint as the current thread while the current thread is halted at that same breakpoint, so control continues to block 555 where the debug engine 150 removes all the found records from the thread history data 158 that comprise a breakpoint instruction address field 310 that matches (is identical to) the current instruction and that comprise a thread identifier field 312 with a thread identifier that is different than the identifier of the current halted thread. The debug engine 150 further sends the current instruction address and the thread identifiers 312 that were removed from the thread history data 158 to the user I/O device 121, either directly or indirectly via the user interface controller 160, where the current instruction address and the thread identifiers 312 are displayed or presented via the user interface 400, as the breakpoint address 402 and other threads 404 that encountered the same breakpoint, respectively. The debug engine 150 optionally presents the thread identifiers with audio or visual effects. In an example visual effect, the debug engine 150 or user interface controller 160 causes the breakpoint address 402 to fade briefly in response to another thread executing the instruction at the breakpoint address 402, such that the more threads that execute the instruction at the address 402, the more the breakpoint address 402 flashes or blinks in the user interface 400. In an embodiment, the debug engine 150 flashes or blinks the breakpoint address and/or breakpoint instruction/statement at a rate proportional to the number of the threads that encounter the all-threads breakpoint address 402 while the current thread is halted.

Control then returns to block 530 where the debug engine 150 again determines whether a command has been received from the user interface of the user I/O device 121, as previously described above.

If the determination at block 550 is false, then the thread history data 158 does not comprise any records comprising a breakpoint instruction address field 310 that matches the current instruction, or the record that matches the current instruction has the same thread identifier 312 as the current thread, so control returns to block 530 where the debug engine 150 again determines whether a command has been received from the user interface of the user I/O device 121, as previously described above. If the determination at block 530 is false, then the debug engine 150 did not receive a command, so control continues to block 550, as previously described above.

A breakpoint that is set (either a user-initiated breakpoint or an all-threads breakpoint) may be encountered by any, some, or all of the thread 154. When a thread encounters a breakpoint and halts, all other threads that did not encounter the breakpoint continue executing, via a technique that is known as non-stop debugging. In an embodiment, the logic illustrated by the logic of FIG. 5 is reentrant, and multiple instances of it may execute in response to multiple threads encountering the same or different breakpoints, so the true and false legs of block 510 may execute simultaneously, substantially simultaneously, or interleaved on the same or different processors via multi-processing, multi-tasking, multi-threading, or multi-programming techniques.

In another embodiment, as an alternative to the processing of blocks 550 and 555 or in addition to the processing of blocks 550 and 555, the debug engine 150 reads the call stacks of all the threads to find the procedures, routines, modules, or methods in which all of the threads are executing and sends identifiers to the user interface of the threads that are executing in the same procedure, routine, module, or other unit of the program as is the halted thread. The user interface receives and displays the identifiers via the user I/O device 121.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention.

In the previous description, numerous specific details were set forth to provide a thorough understanding of embodiments of the invention. But, embodiments of the invention may be practiced without these specific details. In other instances, well-known circuits, structures, and techniques have not been shown in detail in order not to obscure embodiments of the invention. Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense.

What is claimed is:

1. A method comprising:
halting execution of a first thread of a plurality of threads of a program at a first instruction;
determining a subset of the plurality of threads that execute the first instruction while the first thread is halted at the first instruction; and
presenting identifiers of the subset of the plurality of threads that execute the first instruction while the first thread is halted at the first instruction via a user interface for the first thread.

2. The method of claim 1, wherein the determining further comprises:
setting an all-threads breakpoint at the first instruction while the first thread is halted at the first instruction.

3. The method of claim 2, further comprising:
blinking a display of the first instruction at a rate proportional to a number of the subset of the plurality of threads that encounter the all-threads breakpoint while the first thread is halted.

4. The method of claim 2, further comprising:
removing the all-threads breakpoint at the first instruction in response to a command that requests resuming execution of the first thread.

5. The method of claim 2, wherein the determining further comprises:
in response to the subset of the plurality of threads encountering the all-threads breakpoint, saving the identifiers of the subset of the plurality of threads.

6. The method of claim 5, wherein the determining further comprises:
resuming execution of the subset of the plurality of threads without giving control to respective user interfaces for the subset of the plurality of threads.

7. The method of claim 1, wherein the determining further comprises:
setting a first all-threads breakpoint at an entry instruction of a procedure in the first thread that was executing at a time that the first thread halted and that comprises the first instruction; and
setting a second all-threads breakpoint at an exit instruction of the procedure.

8. A computer-readable storage medium encoded with instructions, wherein the instructions when executed comprise:
halting execution of a first thread of a plurality of threads of a program at a first instruction;
determining a subset of the plurality of threads that execute the first instruction while the first thread is halted at the first instruction; and
presenting identifiers of the subset of the plurality of threads that execute the first instruction while the first thread is halted at the first instruction via a user interface for the first thread.

9. The computer-readable storage medium of claim 8, wherein the determining further comprises:
setting an all-threads breakpoint at the first instruction while the first thread is halted at the first instruction.

10. The computer-readable storage medium of claim 9, further comprising:
blinking a display of the first instruction at a rate proportional to a number of the subset of the plurality of threads that encounter the all-threads breakpoint while the first thread is halted.

11. The computer-readable storage medium of claim 9, further comprising:
removing the all-threads breakpoint at the first instruction in response to a command that requests resuming execution of the first thread.

12. The computer-readable storage medium of claim 9, wherein the determining further comprises:
in response to the subset of the plurality of threads encountering the all-threads breakpoint, saving the identifiers of the subset of the plurality of threads.

13. The computer-readable storage medium of claim 12, wherein the determining further comprises:
resuming execution of the subset of the plurality of threads without giving control to respective user interfaces for the subset of the plurality of threads.

14. The computer-readable storage medium of claim 8, wherein the determining further comprises:
setting a first all-threads breakpoint at an entry instruction of a procedure in the first thread that was executing at a time that the first thread halted and that comprises the first instruction; and
setting a second all-threads breakpoint at an exit instruction of the procedure.

15. A computer system comprising:
a processor; and
memory communicatively coupled to the processor, wherein the memory is encoded with instructions, wherein the instructions when executed on the processor comprise:
halting execution of a first thread of a plurality of threads of a program at a first instruction,
determining a subset of the plurality of threads that execute the first instruction while the first thread is halted at the first instruction, wherein the determining further comprises setting an all-threads breakpoint at the first instruction while the first thread is halted at the first instruction, and
presenting identifiers of the subset of the plurality of threads that execute the first instruction while the first thread is halted at the first instruction via a user interface for the first thread.

16. The computer system of claim 15, wherein the instructions further comprise:
blinking a display of the first instruction at a rate proportional to a number of the subset of the plurality of threads that encounter the all-threads breakpoint while the first thread is halted.

17. The computer system of claim 15, wherein the instructions further comprise:
removing the all-threads breakpoint at the first instruction in response to a command that requests resuming execution of the first thread.

18. The computer system of claim 15, wherein the determining further comprises:
in response to the subset of the plurality of threads encountering the all-threads breakpoint, saving the identifiers of the subset of the plurality of threads.

19. The computer system of claim 18, wherein the determining further comprises:
resuming execution of the subset of the plurality of threads without giving control to respective user interfaces for the subset of the plurality of threads.

20. The computer system of claim 15, wherein the determining further comprises:
setting a first all-threads breakpoint at an entry instruction of a procedure in the first thread that was executing at a time that the first thread halted and that comprises the first instruction; and
setting a second all-threads breakpoint at an exit instruction of the procedure.
